(19) United States
(12) Patent Application Publication
(10) Pub. No.: US 2013/0124664 A1
(43) Pub. Date: May 16, 2013

(54) COORDINATING MEDIA PRESENTATIONS AMONG PEER DEVICES

(71) Applicants: Benedito J. Fonseca, JR., Glen Ellyn, IL (US); Kevin L. Baum, Rolling Meadows, IL (US); Faisal Ishtiaq, Chicago, IL (US)

(72) Inventors: Benedito J. Fonseca, JR., Glen Ellyn, IL (US); Kevin L. Baum, Rolling Meadows, IL (US); Faisal Ishtiaq, Chicago, IL (US)

(73) Assignee: MOTOROLA MOBILITY, INC, Libertyville, IL (US)

(21) Appl. No.: 13/297,609

(22) Filed: Nov. 16, 2011

(51) Int. Cl. G06F 15/16

(52) U.S. Cl. 709/208

(57) ABSTRACT

A group of “servant” devices each downloads a media presentation and renders the presentation to a local user. However, a “master” device directs the servants as to which chunks to download and when to render the presentation. In this way, the master keeps the presentations on the separate servants in synchrony. The master uses status information from the servants to coordinate the downloads. If, for example, one servant is having a difficult time keeping up with the presentation, then the master may choose to direct that servant to download a reduced-resolution version of the presentation (which requires less bandwidth to download). If the user of one of the servant devices enters a playback command, then that command is not executed locally but is instead sent to the master device which in turn sends the command to all of the servants so that they may execute the playback command in synchrony.

### FIELD OF THE INVENTION

The present invention is related generally to data-delivery systems and, more particularly, to systems that send or receive media presentations.

### BACKGROUND OF THE INVENTION

More and more users are downloading more and more media presentations to more and more devices. (Here, “media presentations” generally include just about any kind of digital content, and, more specifically, sound, video, and interactive files.) These media presentations are often enormous, and downloading them can consume a significant amount of available bandwidth and battery power on the user's device.

In order to manage download requests, download servers often divide a large media presentation into consecutive “chunks” where each chunk represents, for example, a few seconds of video. When a user wishes to consume a media presentation, his device begins by requesting a “playlist” for the presentation from the download server. (Note that here “consume” is meant as a general term for any type of human interaction with a medium. It can include watching television, listening to radio, playing a computer game, talking or texting on a telephone, interacting with a web site, and the like. To simplify the present discussion, a media consumer is generally called a “user” or a “viewer,” even when his medium of choice does not have a visual portion.) The playlist includes a list of descriptions of the chunks into which the presentation is segmented on that server (including alternative resolutions). With the playlist in hand, the user's device asks the server to download the first chunk of the presentation. While the user is viewing the first chunk, his device attempts to “keep ahead” of the user's viewing (and thus avoid “video freeze”) by requesting subsequent chunks of the presentation. The chunks are received and buffered on the user's device so that the user can continue to view the media presentation while subsequent chunks are still being delivered.

Now consider the situation where a small number of people, say a group of friends, wishes to share the experience of simultaneously watching a video presentation in the same room, but each person wants to watch on his own device. (The room might not have a large-screen television, for instance.) The chunked-download model described above does not work so well in this case. While each person can download chunks of the presentation in the manner discussed above, the separate devices can have different download characteristics which will alter exactly when the next chunk becomes available for playing on a given device. Also, the download requests made by one device will compete with the requests of another device. The net result is that each person may be watching at a slightly different point in the presentation. This lack of shared timing can ruin the shared experience when, say, the friends are watching a soccer match together and one person reacts loudly to an exciting goal while another person still has a few seconds to watch before he can see the goal.

### BRIEF SUMMARY

The above considerations, and others, are addressed by the present invention, which can be understood by referring to the specification, drawings, and claims. In a chunked-download environment, according to the present invention, a group of “servant” devices (e.g., smart phones or tablet computers) each downloads a media presentation and renders the presentation to a local user. However, a “master” device directs the servants as to which chunks to download and when to render the presentation. In this way, the master keeps all of the presentations on all of the separate servants in synchrony.

In some embodiments, the master is a peer of the servants, and the group of them may choose which is to be the master. In other embodiments, the master is a network server dedicated to supporting synchronized playback.

The master can request status reports from the servants including, for example, buffer status, download progress, reception quality, and the like. The master uses this information to coordinate the downloads of the servants, which may have very different download capabilities. If, for example, one servant is having a difficult time keeping up with the presentation (as reflected in the status reports it sends to the master), then the master may choose to direct that servant to download a reduced-resolution version of the presentation. This version requires less bandwidth and may thus allow this servant to keep up with the others.

If the user of one of the servant devices enters a playback command (e.g., play, stop, pause, fast-forward, skip), then the command is not executed directly on the servant device but is instead sent to the master device. The master then sends the command to all of the servants so that they may execute the playback command in synchrony.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a generalized schematic of some of the devices shown in FIG. 1;

FIG. 3 is a flowchart of a method for a servant device to receive and render a media presentation in the representational environment of FIG. 1; and

FIGS. 4a and 4b together form a flowchart of a method for a master device to coordinate servant devices in receiving and rendering a media presentation in the representational environment of FIG. 1.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

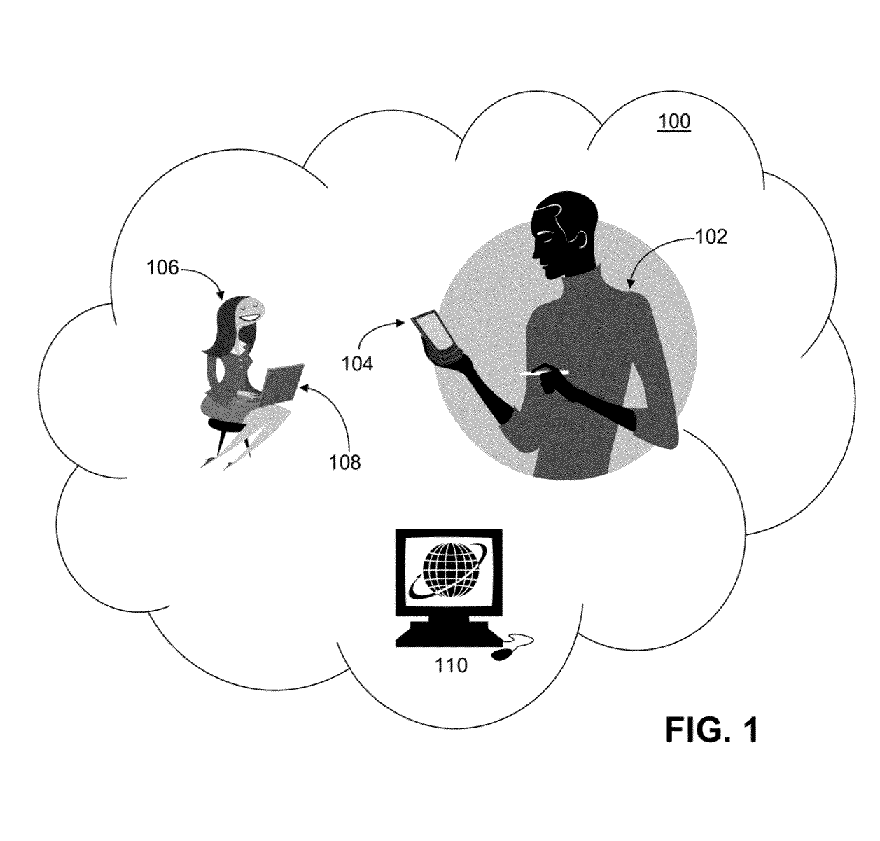

Aspects of the present invention may be practiced in the representative communications environment 100 of FIG. 1. Shown are two friends 102, 106 who wish to simultaneously watch a media presentation, such as a live football game. (Here, “media presentations” generally include just about any kind of digital content, and, more specifically, sound, video, and interactive files.) However, the friends 102, 106 do not have access to a screen large enough for both of them to watch. Instead, friend 102 has a smart phone 104, and friend 106 has a laptop computer 108. (Other possible end-user devices include a gaming console and a television set-top box.) The present invention allows the friends 102, 106 to watch the game on their respective end-user devices 104, 108, while the two presentations stay synchronized in time. This synchronization creates a unified viewing experience for the two friends 102, 106 even though they are viewing the game on their separate devices 104, 108.

The web server icon 110 in FIG. 1 stands for any number of web servers that perform different tasks. One or more web servers 110 are “download” servers that provide the chunks of the media presentation that the friends 102, 106 are watching. Another web server 110, distinct from the download servers, may serve as a “master” device synchronizing the separate viewings on the “servant” devices 104, 108. As explained below, in some embodiments, one of the end-user devices 104, 108 becomes the master and coordinates the viewing of the end-user devices 104, 108 without the need for a separate master server 110.

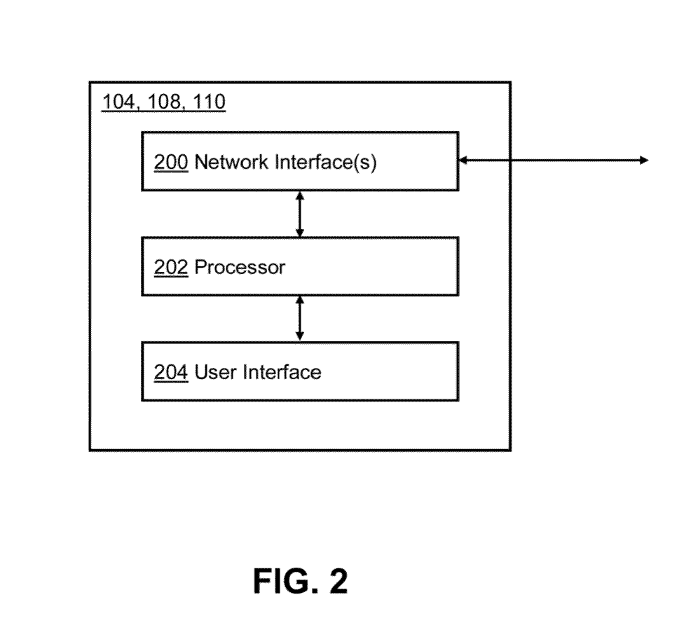

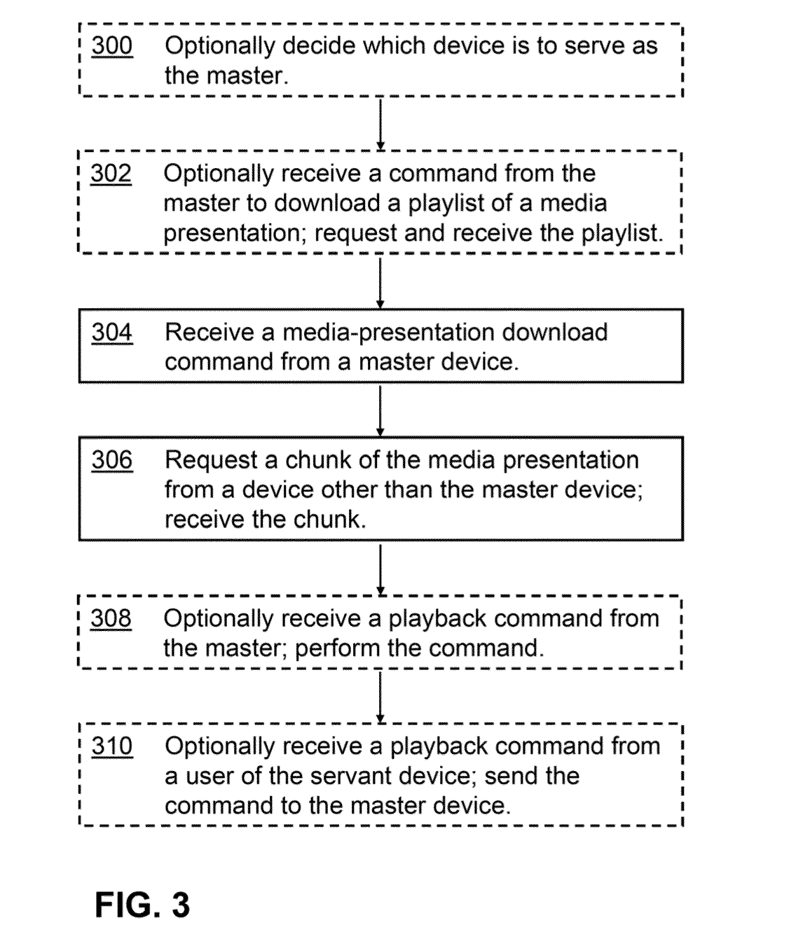

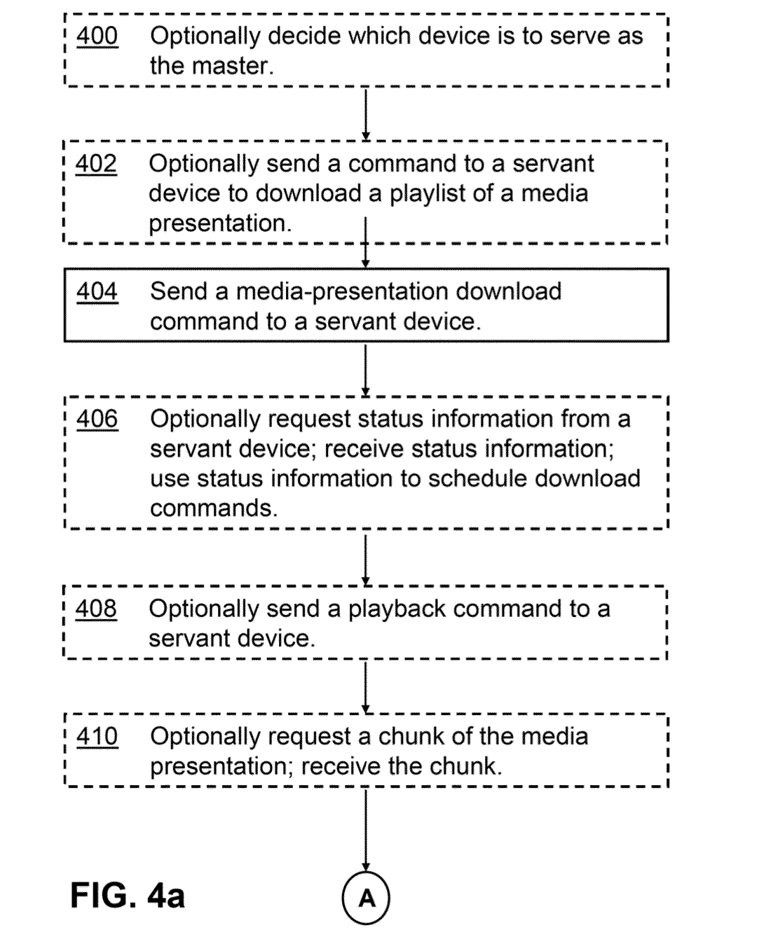

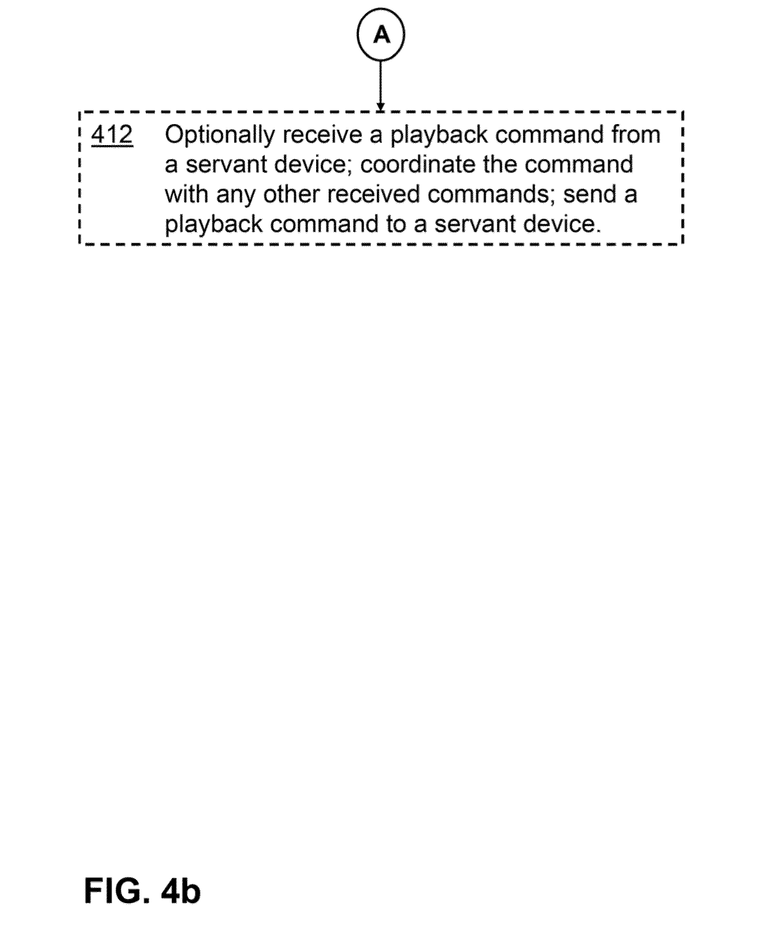

FIG. 2 shows the major components of a representative end-user device 104, 108 or web server 110. Network interfaces 200 send and receive media presentations, related information, and download requests. In addition, the network interfaces 200 are used in synchronizing the end-user devices 104, 108, as described below in relation to FIGS. 3 and 4. A processor 202 controls the operations of the end-user devices 104, 108 and of the web server 110 and, in particular, supports aspects of the present invention as illustrated in FIGS. 3 and 4. The user interface 204 supports a user's (or administrator's) interactions with the device. Specific uses of these components by specific devices are discussed as appropriate below.

(Note that the flowcharts are primarily intended to support the following discussion. The “steps” in the flowcharts are, in some embodiments and in some situations, optional and may be performed in a different order, if at all.)

FIG. 3 presents a method, according to aspects of the present invention, for a servant end-user device 104 to render a media presentation to its user 102 so that the rendering is synchronized with the rendering of at least one other end-user device 108. Before the method of FIG. 3 begins, the participants 102, 106 decide on a media presentation that they would like to view together. It is anticipated that the present invention will most often be practiced in an environment where the participants 102, 106 are near enough to one another that they can use normal speech to make this decision. It is possible, however, that the participants 102, 106 reside in different localities and that they can use the communications abilities of their devices 104, 108 when communicating to decide on a media presentation to watch. (This latter scenario is considered to be less likely simply because the synchronization provided by aspects of the present invention is less vital when the participants 102, 106 are far removed from one another.)

However the media presentation is selected, step 300 optionally chooses one device, either an end-user device 104, 108 or the server 110, to be the master that coordinates the presentation. If the end-user device 104 is chosen as the master, then, because it also serves as the servant for its participant 102, the device 104 performs the methods of both FIGS. 3 (servant) and 4 (master). When the web server 110 is chosen as the master, it would generally not also be a servant device.

In step 302, each participating servant device 104 receives from the master a command to download the playlist for the chosen media presentation. (The playlist may also be called a “manifest” or a “media-presentation description.”) The playlist contains information (such as the number of chunks, playing time duration of each chunk, supported resolutions, and the like) about the chosen media presentation. Note that, in general, the servant device 104, 108 does not request the playlist from the master: Instead, the playlist is requested from a download server 110. Different servant devices 104, 108 may choose to request the playlist from different download servers 110 to avoid contention.

Under the direction of the master, the participating servant device 104 receives a download command in step 304 and performs that command in step 306. There are several types of download commands. The most common specifies which chunks the end-user device 104 should request from a download server 110. The download command could also specify what resolution to download, when to download, and an identification of where within a downloaded chunk the servant device 104 should begin decoding the chunk or queuing the chunk for playback. If the download command includes a value for the resolution, then the servant device 104 can interpret this value as the maximum resolution to download, because the servant device 104 may decide that it needs to download at a lower resolution than specified.

(Note: There is some confusion in the art about the meaning of a “chunk” that is relevant here. Sometimes, a “chunk” is equated with a given time segment of a video presentation, regardless of the coding resolution of that time segment. That is to say, the first two-second segment is a “chunk” that can be encoded at different resolutions. Other times, each resolution of that first two-second segment is considered to be a different “chunk.” In the present discussion, the master generally decides both which chunk to download next and at what resolution, so the distinction is meaningless to the servant device 104.)

The servant device 104 may receive a playback command from the master in step 308. The master sends these commands to synchronize the playback on the separate participating servants 104, 108. In addition to the straightforward play, stop, and pause commands, the master could send a playback command for a “trick play” such as fast-forward, rewind, skip to a specified place in the media presentation, play in slow motion, highlight, and play an alternate audio track. As discussed below, the master in some embodiments monitors the buffer status of all of the participating servant devices 104, 108, so that the master knows that all of the servants 104, 108 are ready to respond to the playback command. In this way, the master synchronizes the disparate playbacks of the servants 104, 108.

In step 310, the servant device 104 also receives a playback command, but in this case the command is from its local user 102. The user 102 may enter the same types of commands (e.g., play, fast-forward) that the servant device 104 receives from the master in step 308. However, in this case the servant device 104 does not directly perform the command. Instead, it sends the command to the master device. Discussed below is what the master does with the received playback command.

FIGS. 4a and 4b present a method for a master device, whether the master is an end-user device 104, 108 or a web server 110. Many of the steps in this method are the other end of the communications described above in relation to the servant end-user device 104 and thus need only a brief discussion here.

In optional step 400 (as in step 300 of FIG. 3, discussed above), the participating end-user devices 104, 108 choose a master.

As appropriate, in step 402 the master tells the servant end-user devices 104, 108 to download the playlist of the chosen media presentation. (See the discussion of step 302 of FIG. 3.)

In step 404, the master tells each servant device 104, 108 to download some of the media presentation (step 304 of FIG. 3). Note that in some embodiments, the servant devices 104, 108 need not be given the exact same commands here. Consider the optional step 406. In that step, the master device requests status information from the servant devices 104, 108. That information can include a number of things such as the instantaneous download capacity of each device 104, 108 (which can depend upon, for example, the download bandwidth currently available as well as on specific capacities of each device 104, 108), buffer capacity, how much of the media presentation each device 104, 108 has actually received, and even remaining battery charge. The master uses this information to try to keep the servants 104, 108 synchronized. If, for example, one servant 104 is having difficulty “keeping up” with the downloads (perhaps because of the competition for download bandwidth with the other servant devices), then the master may command that servant 104 to download a lower bandwidth version of the shared media presentation. (Of course, downloading a media presentation at lower resolution saves significant bandwidth and battery power compared to downloading the same presentation at a higher resolution.) The master device can also instruct the servant devices 104, 108 to download chunks at overlapping or non-overlapping time periods. In some cases, for example, when the servant devices 104, 108 download chunks through a shared wireless medium prone to competition for download bandwidth, such as a WiFi channel, the master device may instruct the servant devices 104, 108 to download chunks at non-overlapping time periods. Such behavior by the master avoids competition for download bandwidth between the servant devices 104, 108. In this example, the servant devices 104, 108 use a communication protocol to receive the download command messages and to send messages indicating the conclusion of the chunk download.

A servant 104 may also send status information to the master without being queried. For example, the servant 104 may experience a “video freeze” when its playback reaches the end of the amount of the presentation that it has already downloaded. The servant 104 tells the master of this fact. The master may choose to send a “pause” playback command to all servants 104, 108 to allow the servant 104 to catch up with its downloading. The master may also lower the resolution of the downloads if a lack of bandwidth seems to be the problem. When all of the servants 104, 108 are ready to proceed, the master can issue a “play” command.

In another alternative, the master determines the status of the servant 104 by passively monitoring the download environment. For example, by “sniffing” the air (that is, by examining download requests and responses that the master reads on the airwaves), the master can see that the servant 104 has not yet begun to receive a chunk that is scheduled for playing very soon. The master can respond to this situation, by, for example, querying the servant 104 for a more detailed status report, or sending a particular download command to the servant 104, or even pausing all servants 104, 108 until the servant 104 has received that chunk.

In step 408 (see also step 308 of FIG. 3), the master controls the servants' playbacks of the shared presentation. Commands can be sent that adjust the playback timing of the servants 104, 108, so that they stay in close synchronization.

Step 410 emphasizes the fact that the master device may also be playing the media presentation to its local user, that is, the master can also be its own servant. In that case, the master also performs the essentials of the method of FIG. 3.

In step 412 of FIG. 4b, the master receives a playback command from the user of one of the servant devices (which can include the master itself, as discussed above). The servant device does not perform the command (as discussed above in relation to step 310 of FIG. 3), but simply sends the command to the master. This allows the master to keep the playback coordinated among the separate servants 104, 108 while at the same time allowing all of the local users 102, 106 to influence the playback. If the master does not receive conflicting commands from different servants 104, 108, then it can simply implement the command by sending a playback command (step 408) to the servants 104, 108. Sometimes this is not immediately possible, however. For example, the received command can call for skipping ahead in the presentation, but one servant 104 may not yet have downloaded the appropriate chunk. The master may then decide to ignore the command or postpone it while commanding the servant 104 to catch up by downloading the appropriate chunks, possibly at a lower resolution.

If the master receives conflicting commands in step 412, then it can decide which, if any, to implement. It might also prevent confusion by ignoring a command that comes too closely after another. It is anticipated that users will become accustomed to the fact that not all of their commands can be immediately performed in this shared-presentation environment.

Some embodiments allow a servant to join the group after the playback has begun. This new servant notifies the master of its intent, and the master calculates when that servant will have enough material downloaded to begin playing back in synchrony with the existing members of the group. The master then sends download commands (step 404) to the joining servant device and, when the new servant is ready, sends it a playback command synchronizing it with the other servants 104, 108 (step 408).

In view of the many possible embodiments to which the principles of the present invention may be applied, it should be recognized that the embodiments described herein with respect to the drawing figures are meant to be illustrative only and should not be taken as limiting the scope of the invention. For example, the master can choose to use any of various communications protocols in synchronizing the playback of the servant devices. Therefore, the invention as described herein contemplates all such embodiments as may come within the scope of the following claims and equivalents thereof.

We claim:

1. A method for a servant end-user device to receive media content, the method comprising:
receiving, by the servant end-user device from a master device, a download command;
sending, by the servant end-user device to a download server distinct from the master device, a request for a chunk of a media presentation, the request based, at least in part, on the received download command; and
receiving, by the servant end-user device from the download server, the requested chunk of the media presentation.

2. The method of claim 1 wherein the servant end-user device is selected from the group consisting of: a mobile telephone, a set-top box, a personal computer, a tablet, and a gaming console.

3. The method of claim 1 wherein the download command comprises an element selected from the group consisting of: an identification of which chunk to download, an identification of what resolution to download, an identification of when to download the chunk, an identification of a byte of a chunk from which to begin media decoding, and an identification of where to begin playback of the media presentation.

4. The method of claim 1 further comprising:
receiving, by the servant end-user device from the master device, a playlist-download command;
sending, by the servant end-user device to the download server, a request for a playlist of a media presentation, the request based, at least in part, on the received playlist-download command; and
receiving, by the servant end-user device from the download server, at least part of the requested playlist of the media presentation.

5. The method of claim 1 further comprising:
communicating, by the servant end-user device with at least one other device; and
based, at least in part, on the communicating, choosing one device to be the master device.

6. The method of claim 1 further comprising:
receiving, by the servant end-user device from the master device, a playback command; and
based, at least in part, on the received playback command, playing back, by the servant end-user device, at least a portion of the media presentation.

7. The method of claim 6 wherein the playback command is selected from the group consisting of: play, stop, pause, fast-forward, rewind, skip to a specified place in the media presentation, play in slow motion, highlight, play an alternate audio track, and synchronize playback.

8. The method of claim 1 further comprising:
receiving, by the servant end-user device from a user of the servant end-user device, a playback command; and
sending, by the servant end-user device to the master device, the received playback command.

9. A servant end-user device configured for receiving media content, the servant end-user device comprising:
a network interface subsystem configured for receiving a download command from a master device; and
a processor operatively connected to the network interface subsystem and configured for:
sending, via the network interface subsystem to a download server distinct from the master device, a request for a chunk of a media presentation, the request based, at least in part, on the received download command; and
receiving, via the network interface subsystem from the download server, the requested chunk of the media presentation.

10. The servant end-user device of claim 9 wherein the servant end-user device is selected from the group consisting of: a mobile telephone, a set-top box, a personal computer, a tablet, and a gaming console.

11. A method for a master device to coordinate reception of a media presentation on a servant end-user device, the method comprising:
sending, by the master device to the servant end-user device, a command for downloading a chunk of the media presentation, wherein the download command comprises an element selected from the group consisting of: an identification of which chunk to download, an identification of what resolution to download, an identification of when to download the chunk, an identification of a byte of a chunk from which to begin media decoding, and an identification of where to begin playback of the media presentation.

12. The method of claim 11 wherein the master device is selected from the group consisting of: a mobile telephone, a set-top box, a personal computer, a tablet, a gaming console, and a server.

13. The method of claim 11 further comprising:
sending, by the master device to the servant end-user device, a playlist-download command.

14. The method of claim 11 further comprising:
communicating, by the master device with at least one end-user device in a group of end-user devices; and
based, at least in part, on the communicating, choosing one device to be the master device.

15. The method of claim 11 further comprising:
sending, by the master device to the servant end-user device, a playback command.

16. The method of claim 15 wherein the playback command is selected from the group consisting of: play, stop, pause, fast-forward, rewind, skip to a specified place in the media presentation, play in slow motion, highlight, play an alternate audio track, and synchronize playback.

17. The method of claim 11 further comprising:
receiving, by the master device from the servant end-user device, a playback command;
coordinating, by the master device, the received playback command with any other received playback commands; and
based, at least in part, on the coordinating, sending, by the master device to the servant end-user device, a playback command.

18. The method of claim 11 further comprising:
sending, by the master device, a request for a chunk of the media presentation; and
receiving, by the master device, the requested chunk of the media presentation.

19. The method of claim 11 further comprising:
requesting, by the master device, status information from a servant end-user device; and
receiving, by the master device, the requested status information;
wherein sending the command for downloading is based, at least in part, on the received status information.

20. The method of claim 11 further comprising:
receiving, by the master device, download-progress information associated with a servant end-user device;
wherein sending the command for downloading is based, at least in part, on the received download-progress information.

21. A master device configured for coordinating reception of a media presentation on a servant end-user device, the master device comprising:
a network interface subsystem; and
a processor operatively connected to the network interface subsystem and configured for:
sending, via the network interface subsystem to the servant end-user device, a command for downloading a chunk of the media presentation, wherein the download command comprises an element selected from the group consisting of an identification of which chunk to download, an identification of what resolution to download, and an identification of when to download the chunk.

22. The master device of claim 21 wherein the master device is selected from the group consisting of: a mobile telephone, a set-top box, a personal computer, a tablet, a gaming console, and a server.
